(19) United States
(12) Patent Application Publication
(10) Pub. No.: US 2009/0119030 A1
(43) Pub. Date: May 7, 2009

(54) FORCE FEEDBACK AND INTERACTIVE SYSTEM

(75) Inventors: Ming-Chung Fang, Tainan City (TW); Chung-Hung Lin, Tainan City (TW); Ming-Wheng Lin, Hsinchu County (TW); Chien-Chun Kuo, Tainan County (TW); Yu-Shu Hsu, Tainan County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 11/967,212

(22) Filed: Dec. 30, 2007

(30) Foreign Application Priority Data
Nov. 2, 2007 (TW) 096141279

(51) Int. Cl. G01L 5/00; G01M 1/00; A63F 9/24

(52) U.S. Cl. 702/41; 73/65.09; 463/36; 340/665; 463/32; 434/60

(57) ABSTRACT

A force feedback and interactive system is provided in the present invention, wherein the force feedback and interactive system utilizes a mechanism for detecting weight or center of gravity and reacted force from an operator on a multi-axis motion platform, and a main controller which is a kernel of data processing and motion simulating of the multi-axis motion platform. Besides having complete mathematical simulation model for calculating reaction force variation according to the received operating command, force status and weight of the operator and having algorithm for simulating the motion of multi-axis motion platform so as to calculate the motion and instantaneous position of the multi-axis motion platform in space, the system can also provide function of force feedback for enhancing the virtual reality while being applied in various Human-Machine Interaction simulating field.

### FIELD OF THE INVENTION

The present invention relates to a feedback system, and more particularly, to a force feedback system capable of generating an output of feedback in responding to the direction and magnitude of a force detected by the system while using the feedback to interact with a user of the system.

### BACKGROUND OF THE INVENTION

Human-machine interactions are ubiquitous in today's world. It is being applied in almost every high-tech product. For those interactive products such as interactive exercise equipments, interactive training simulators, interactive toys and interactive gaming consoles, the ability for enabling an operator to interact with those interactive products with high virtual reality and thus taste a lived experience of reality not only can increase their attractiveness, but also their playfulness are enhanced.

Recently, following the growing applications in home entertainment, engineering, remote mechanical control and virtue reality, force feedback apparatus is becoming more and more essential as it can increase the overall realism of a simulation by providing a sense of virtual contact. Generally, the force feedback apparatus is substantially a haptic feedback device capable of providing an operator with the feel of touch by generating and transmitting a feedback force to be felt by the operator.

Force feedback apparatuses are most commonly applied in video game industry. It is known that the physical aspect of a video game includes two aspects: Use of the real world as a gaming environment and/or use of physical objects for interaction. Nowadays, most video game manufacturers, such as Nintendo, Sony, Microsoft and Sega, are providing a gaming environment with lavish visual sensation by designing their game consoles to connect with televisions or computer monitors, which is also true for those video game especially configured for PCs and/or PDAs. Nevertheless, with the rapid advance of 3D image processing technology in game consoles, video game manufacturers now try to improve interactions between real players and character configurations in video games by designing force feedback apparatus in their user interfaces, e.g. mouse, joystick, game board, driving wheel, etc., for providing good force response in their games.

There are already many studies relating to such force feedback apparatus. One of which is a drive simulation apparatus, disclosed in U.S. Pat. No. 6,431,872. the aforesaid drive simulation apparatus utilizes a torque-detecting means coupled to a steering wheel at a position underneath the same to detect the swing movements of the steering wheel when it is operated by an operator while enabling a computer to generate a feedback in response to the detected swing movements so as to issue a reactive force to the player. However, the aforesaid apparatus has no way of detecting the weight or center of gravity of the operator, nor can it detect the direction and magnitude of a force exerted by the operator. Moreover, there is no environment status being detected and used as basis for generating the force feedback response.

Another such study is a motion simulator disclosed in U.S. Pat. No. 6,733,293, entitled “Personal Simulator”. In one exemplary embodiment, the motion simulator includes a motion base mounted on a base plate. A chair or similar supporting structure is coupled to the motion base. A controller, adapted to receiving motion commands, generates signals for controlling the motion base. In response to motion commands, the motion base is activated so that a person in the support structure experiences motion synchronized with the displayed audio visual display. However, although the aforesaid motion simulator is able to respond to the command of its operator, it still lacks the ability for detecting the magnitude of a force exerted by the operator and thus generating a force feedback accordingly.

### SUMMARY OF THE INVENTION

The object of the present invention is to provide a force feedback and interactive system, programmed with a complete mathematical simulation model for calculating reaction force variation according to the received operating commands, force status and weight of an operator and having an algorithm for simulating motions of a multi-axis motion platform in the system so as to calculate the motion and instantaneous position of the multi-axis motion platform in space, thereby, the system is able to generate a force feedback in a manner that it can interact with the operator with high virtual reality and thus is suitable for various Human-Machine Interaction simulating applications.

To achieve the above object, the present invention provides a force feedback and interactive system, comprising: a motion platform, capable of performing a multi-axial movement; a force detection/feedback unit, mounted on the motion platform for detecting the magnitude and direction of a force exerted from a limb portion of an operator and thus generating a detection signal accordingly; and a master control unit, coupled to the force detection/feedback unit for enabling the same to perform a calculation basing upon the detection signal and thus generating a control signal to the multi-axis motion platform and a feedback signal to the force detection/feedback unit.

In an exemplary embodiment of the invention, another force feedback and interactive system is provided, which comprises: a motion platform, capable of performing a multi-axial movement; a force detection/feedback unit, further comprising: a hand detection device capable of being mounted on the motion platform for detecting the magnitude and direction of a force exerted from hands of an operator and thus generating a first detection signal accordingly, and a foot detection device capable of being mounted on the motion platform for detecting the magnitude and direction of a force exerted from feet of an operator and thus generating a second detection signal accordingly; and a master control unit, coupled to the force detection/feedback unit for enabling the same to perform a calculation basing upon the first and the second detection signals and thus generating a control signal to the multi-axis motion platform and a feedback signal to the force detection/feedback unit.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram showing a force feedback and interactive system according to an exemplary embodiment of the invention.

FIG. 2 is a block diagram showing a force feedback and interactive system according to another exemplary embodiment of the invention.

FIG. 3 is a three dimensional view of an actuating unit used in the force feedback and interactive system of the invention.

FIG. 4 is a three dimensional view of a hand detection unit used in the force feedback and interactive system of the invention.

FIG. 5A and FIG. 5B are respectively a top view and a side view of a foot detection unit used in the force feedback and interactive system of the invention.

FIG. 6 is a block diagram showing a force feedback and interactive system according to yet another exemplary embodiment of the invention.

FIG. 7 is a flow chart depicting the operating steps being performed in the force feedback and interactive system according of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

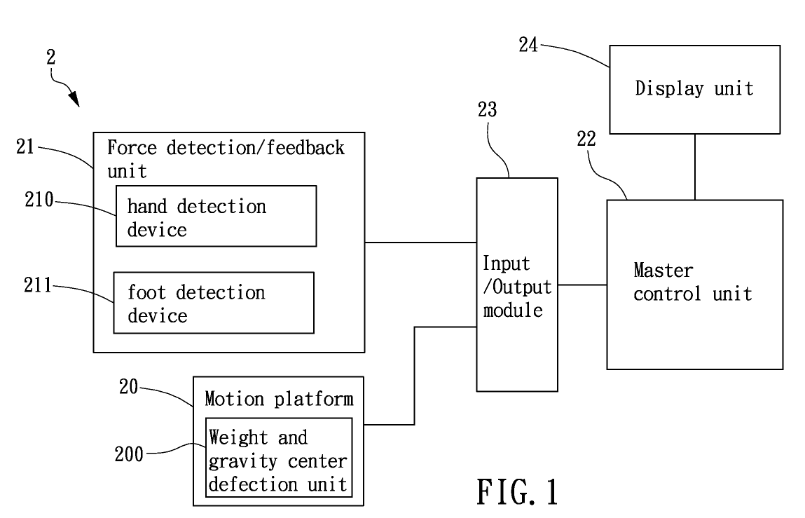

Please refer to FIG. 1, which is a block diagram showing a force feedback and interactive system according to an exemplary embodiment of the invention. In this embodiment, the system 2 comprises a motion platform 20, a force detection/feedback unit 21 and a master control unit. The motion platform 20 is capable of performing a multi-axial movement simulating a specific movable object and thus enhancing the interaction between the system and an operator. It is noted that the motion platform can be shaped like a platform selected from the group consisting of a vehicle, a vessel and an airplane and the like, but is not limited thereby. The force detection/feedback unit 21 is disposed on the motion platform 20 in a manner that it is connected to the master control unit 22 through an input/output (I/O) module 23 so that it can be used for detecting the magnitude and direction of a force exerted from the operator and thus generating a detection signal accordingly which is being transmitted to the master control unit 22 through the I/O module 23. The I/O module 23 can be a signal transmission port, such as RS232, that it is a signal transmission interface known to those skilled in the art and thus is not described further herein.

In the exemplary embodiment shown in FIG. 1, the force detection/feedback unit 21 further comprises a hand detection unit 210 and a foot detection unit 211. However, other than the hands and feet of the operator, the force detection/feedback unit 21 can also be used for detection a force exerting from the waist portion of the operator. Accordingly, depending on actual requirement, the force detection/feedback unit 21 can be configured for detecting forces exerting from any portion of the operator, and thus it is not limited by those described in FIG. 1. The master control unit 22 is configured for performing a calculation basing upon the detection signal and thus generating a control signal to the multi-axis motion platform 20 and a feedback signal to the force detection/feedback unit 21, both through the I/O module 23.

As the master control unit 22 is programmed with a complete mathematical simulation model and having an algorithm for numerical analysis, the control signal generated therefrom contains information relating to motions and instantaneous position of the multi-axis motion platform 20 while the feedback signal also generated therefrom contains information for directing the force detection/feedback unit 21 to produce a feedback response with respect to how larger and where the feedback force should be felt by the operator. Accordingly, as soon as the control signal is received by the motion platform 20, the motion platform 20 will perform a multi-axial movement according to the direction of the control signal. Similarly, as soon as the feedback signal is received by the force detection/feedback unit 21, a feedback response is generated to be felt by the operator. It is noted that the feedback response can be a reactive force or a torque for interacting with the operator.

In addition, the master control unit 22 is coupled to a display unit 24, which can display images in response to the calculation result of the master control unit 22, thereby it can enable the operator to interact with the system 2 with high virtual reality and thus taste a lived experience of reality. The display unit 24 can be a flat panel displayer, such as a plasma TV, an LCD TV, or a projector, but is not limited thereby. Moreover, the system further comprises a weight and gravity center detection unit 200, which is disposed on a surface of the motion platform 20 for detecting the weight and gravity center of the operator so as to be used as input to the master control unit 22.

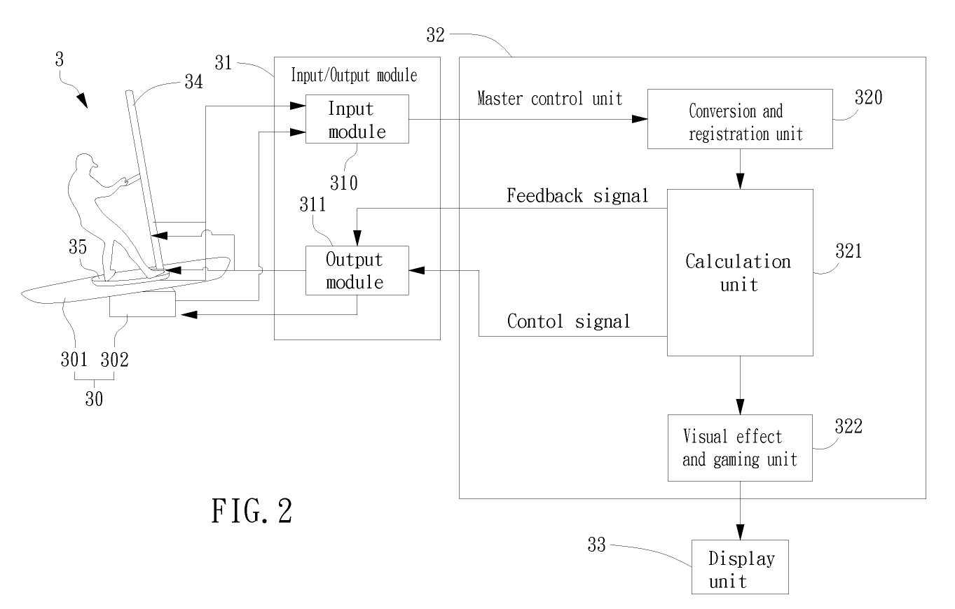

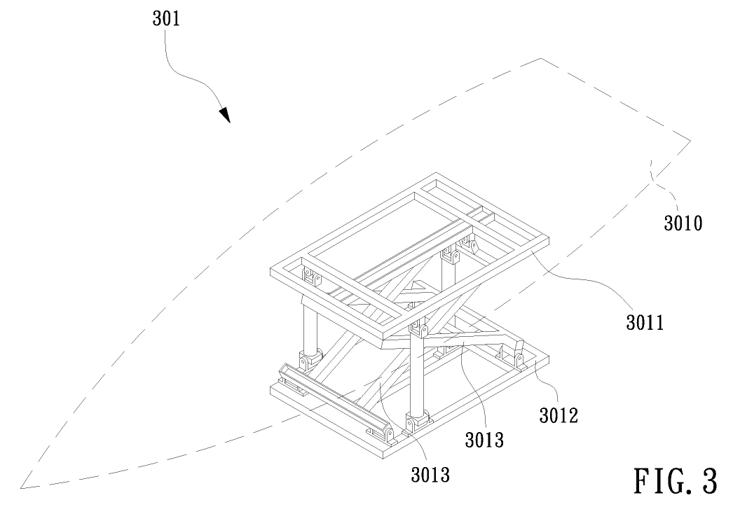

Please refer to FIG. 2, which is a block diagram showing a force feedback and interactive system according to another exemplary embodiment of the invention. The system 3 comprises a motion platform 30, an I/O module 31, a master control unit 32 and a display unit 33. The motion platform 30 further comprises a frame 301 and an actuating unit 302, in which the frame 301 is shaped like a sailing boat and the actuating unit 302 is capable of driving the frame 301 to perform a multi-axial movement of multiple-degree-of-freedom so that the position and movement of the carrier frame is controlled thereby. Please refer to FIG. 3, which is a three dimensional view of an actuating unit used in the force feedback and interactive system of the invention. As shown in FIG. 3, the frame 301 is further comprised of a hull 3010, a carrier 3011, a base 3012 and a pair of safety stops 3013. The hull 3010 is used for supporting the body of the operator is designed responding to the requirement of a specified scenario, so that it can be shaped like a hull of a sailing boat, a surfboard, vehicle, or an airplane, etc. The carrier 3011 is connected to a side of the frame 3010 while the base 3012 is arranged at a side of the carrier 3011.

The pair of safety stops 3013 are sandwiched between the carrier 3011 and the base 3012 while each of the two safety stops 3013 is coupled to the carrier 3011 and the base 3012 in respective. It is noted that each safety stop 3013 is a security device capable of restricting the hull 3010 only to move within a specific range. In FIG. 3, the actuating unit 302 is used for driving the frame 301 to move, and generally, the actuating unit 302 is able to drive the frame to perform a six-axial movement, a three-axial movement or a two-axial movement, but is not limited thereby. Moreover, there can be a variety of designs for the frame 301 that are not limited by that shown in FIG. 3 and also are known to those skilled in the art.

As shown in FIG. 2, the hand detection unit 34 and the foot detection unit 35 are all mounted on the frame 301 in a manner that the hand detection device 34 is mounted on the motion platform 30 for detecting the magnitude and direction of a force exerted from hands of an operator and thus generating a first detection signal accordingly; and the foot detection device 35 is also mounted on the motion platform 30 for detecting the magnitude and direction of a force exerted from feet of the operator and thus generating a second detection signal accordingly. The first detection signal is transmitted to the master control unit 32 by the input module 310 of the I/O module 31, in which the input module 310 is able to digitize the information relating to the force magnitude and direction by the use of an A/D converter and then transmitted the digitized information to the master control unit 32 either directly or by way of a signal transmission port, such as RS232.

Similarly, the second detection signal is transmitted to the master control unit 32 by the input module 310 of the I/O module 31, in which the input module 310 is able to digitize the information relating to the force magnitude and direction, and the weight and gravity center of the operator by the use of an A/D converter and then transmitted the digitized information to the master control unit 32 either directly or by way of a signal transmission port, such as RS232. In this exemplary embodiment, since the frame 301 is shaped like a sailing boat, the hand detection unit 34 can be designed as the steering wheel capable of controlling the sail of the sailing boat. Moreover, for enhancing reality, parameters acquired by the use of the foot detection unit 35 with respect to the magnitude and direction of the force exerted from the feet of the operator are send to the master control unit 32 for simulating sailing in virtual reality.

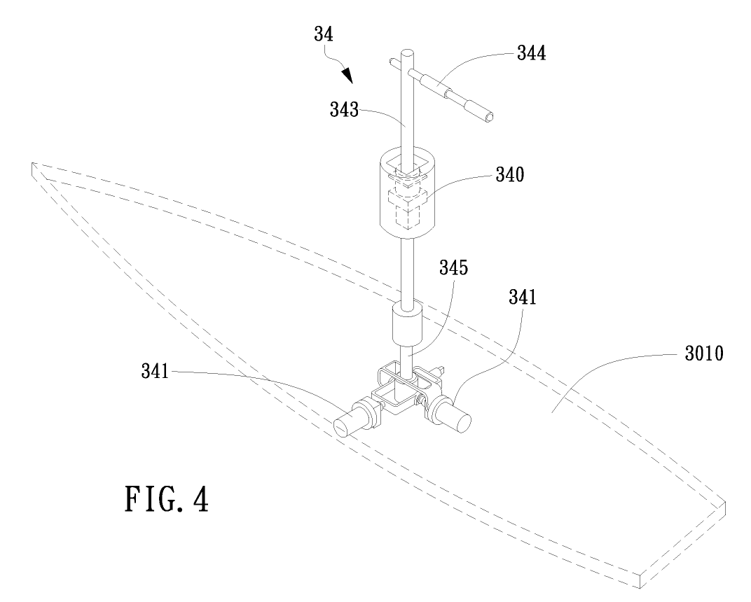

Please refer to FIG. 4, which is a three dimensional view of a hand detection unit used in the force feedback and interactive system of the invention. The hand detection unit 34 further comprises a plurality of detecting/driving components as the those detecting/driving components 340 and 341 shown in FIG. 4, in which the detecting/driving component 340 is used for torque detection and feedback generation with respect to an coordinate axis of a Cartesian coordinate system of X-, Y-, and Z-axes perpendicular to the planar surface where the frame 310 is positioned, i.e. the Z-axis, while the two detecting/driving components 341 are used for torque detection and feedback generation with respect to the X-axis and Y-axis of the Cartesian coordinate system in respective, and thereby, the hand detection unit 34 is able to detect torque and thus respond in three-dimensional space. In this exemplary embodiment, the detecting/driving components 340 and 341 are driving motors which are known to those skilled in the art and thus are not described further herein. In FIG. 4, a controlling rod 343 is connected to a side of the detecting/driving component 340 and further there is a pushing rod 344 connected to the controlling rod 343 at an end thereof away from the detecting/driving component 340. In addition, the two detecting/driving components 341 is electrically connected to the master control unit by a rod 345.

Thus, a force exerted on the controlling rod 343 by an operator can be detected by the detecting/driving components 340 and 341m by which a first detection signal is generated and transmitted to the master control unit 32. As soon as the first detection signal is received by the master control unit 32, it will start a calculation basing on the received first detection signal and then respond with a feedback signal back to the detecting/driving components 340 and 341 through the I/O module 31. Then, the detecting/driving components 340 and 341 will generate a force feedback to be felt by the operator according to the feedback signal. It is noted that the hand detection device can be various and thus is not limited by the one described in the exemplary embodiment shown in FIG. 4.

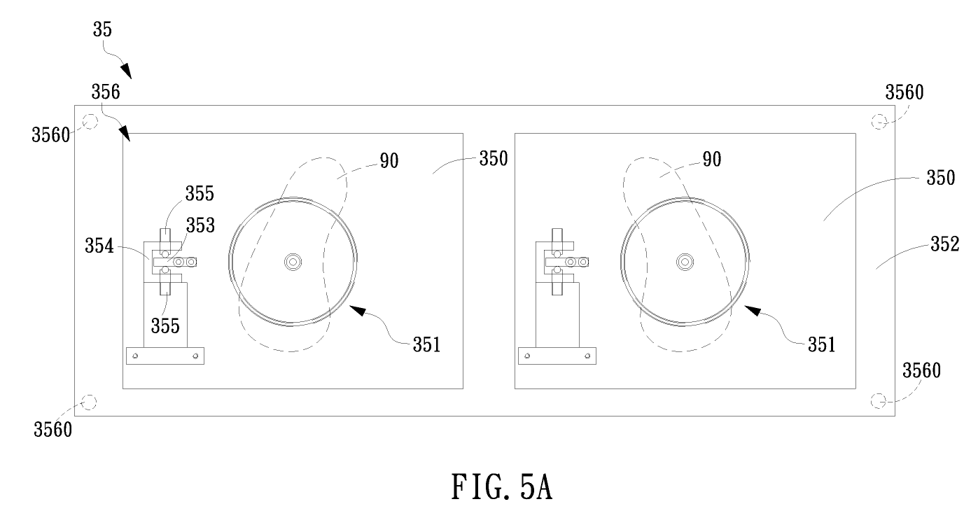

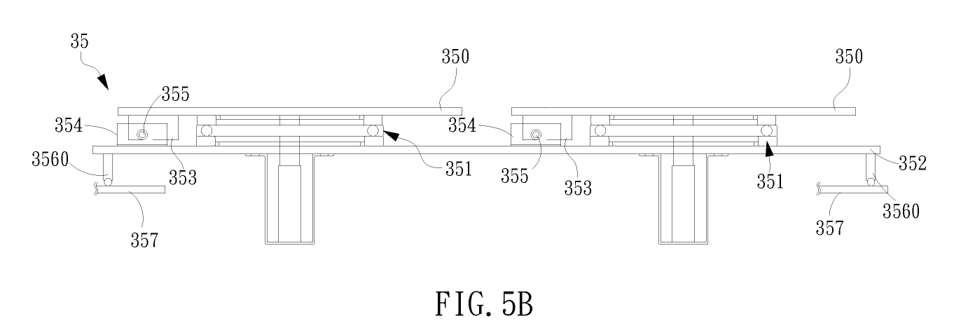

Please refer to FIG. 5A and FIG. 5B, which are respectively a top view and a side view of a foot detection unit used in the force feedback and interactive system of the invention. As shown in the two figures, the foot detection unit 35 has two supporting boards 350 for supporting the two feet 90 of an operator, that is, the operator is able to stand on the foot detection unit 35 by stepping his/her two feet 90 on the two supporting boards 350 respectively. Each of the two supporting boards 350 is coupled to a rotating device 351 while the bottom of the rotating device 351 is fixedly secured on a fixed plate 352. As each rotating device 351 is coupled to its corresponding supporting board 350 by a rotatable component configured therein, any motion of the feet of the operator is able to drive the rotatable component to rotate accordingly and thus bring along the supporting board to turned as well, In an exemplary embodiment, the rotatable component used in the rotating device 351 is a ball bearing which is coupled to the supporting board 350 by the bushing thereof and is fixed to the fixed plate 352 by the bottom thereof. Thereby, the supporting board 350 is able to rotate about the bushing. It is noted that there can be other rotatable component capable of being used in the rotating device and thus it is not limited to the aforesaid ball bearing.

For measuring the magnitude and direction of a force exerted from the feet of an operator standing on the supporting boards 350, a block 353 is attached upon each of the two the supporting boards 350 at a surface facing toward the fixed plate 352 while a concave seat 354 is mounted on the fixed plate 352 at a position corresponding to the block 353, for enabling a sensor 355, disposed inside the of the concave of the concave seat 354 to be arranged at positions corresponding to the block 353. By the concave seat 354 and the block 353, the movement of their corresponding supporting board 350 is restricted to rotate only within a specific small angle beneficiary for detecting the foot movement of the operator. When a movement of a feet of the operator cause a steering torque on its corresponding supporting board 350, the block 353 mounted on the referring supporting board will be brought along and thus moved accordingly to come into contact with the sensor 355 fitted inside the concave seat 354. Thereby, the sensor 355 is able to issue a second detection signal according to the contact and then send the second detection signal to the master control unit 32 through the I/O module 31.

In addition, the foot detection unit 35 further comprises a weight and gravity center detection unit 356. In this exemplary embodiment, the weight and gravity center detection unit 356 has four weight sensors 3560 disposed at the four corners of the fixed plate 352 in a manner that each is placed on top of a brace panel 357. Thereby, when the operator is standing on the supporting boards, his/her weight can be detected by the four weight sensors 3560 which will then transmit signals to the master control unit 32 for analysis so as to conclude the gravity center variation of the operator. As for the amount of the weight sensor 3560 as well as where are they going to be positioned are dependent upon actual requirement that are not limited by the aforesaid embodiment. Moreover, the aforesaid weight sensor 3560 as well as the weight and gravity center detection unit 356 are all known to those skilled in the art and thus are not described further herein.

As shown in FIG. 2, the master control unit 32 is comprised of a conversion and registration unit 320, a calculation unit 321 and a visual effect and gaming unit 322. The conversion and registration unit 320 is used for recording the magnitude and direction of all the forces detected by the force detection/feedback unit in real time manner while converting the detection result into stress with respect to a specific stress unit conforming to a specific application and then transmitting the converted stress to the calculation unit 321. The calculation unit 321 is used for performing a calculation basing upon the conversion result of the conversion and registration unit 320 so as to obtain a control signal and a feedback signal. That is, the calculation unit 321 will feed the converted stress into the mathematical simulation model and numerical analysis algorithm programmed therein so as to obtain the control signal and the feedback signal, in which the control signal contains information relating to motions and instantaneous position of the multi-axis motion platform 30 while the feedback signal contains information for directing the force detection/feedback unit to produce a feedback response with respect to how larger and where the feedback force should be felt by the operator.

Thereafter, the output module 311 of the I/O module 31 is used for transmitting the control signal and the feedback signal through the signal transmission port (such as RS232) and the D/A converter to the hand detection unit 34, the foot detection unit 35 and the motion platform 30. Moreover, the master control unit further comprises a visual effect and gaming unit 322, which is able to transmit signal corresponding to the calculation result of the calculation unit 321 to a display unit 33. The display unit is able to display images in response to the calculation result of the master control unit 321, thereby it can enable the operator to interact with the system 3 with high virtual reality and thus taste a lived experience of reality. The display unit 24 can be a flat panel displayer, such as a plasma TV, an LCD TV, or a projector, but is not limited thereby.

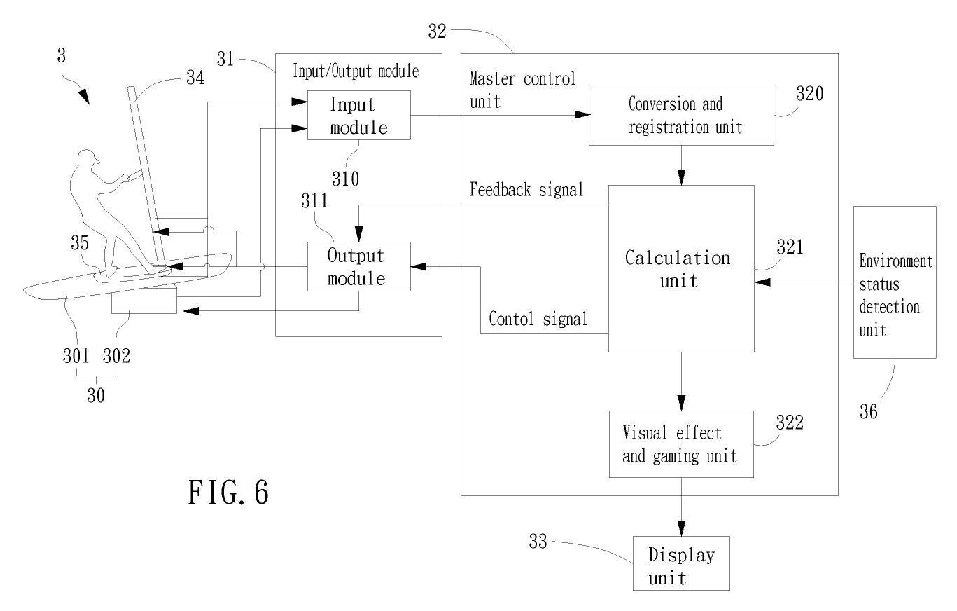

Please refer to FIG. 6, which is a block diagram showing a force feedback and interactive system according to yet another exemplary embodiment of the invention. In this exemplary embodiment, the master control unit 32 further connected to an environment status detection unit 36, which is capable of detecting status of ambient environment or receiving environment status inputted from an operator so as to be used as calculation basis for the calculation unit. As the motion platform 30 is shaped like a vessel, the environment status detected by the environment status detection unit 36 is those parameters relating to the orientation and power of wind as well as the orientation, power and height of wave. Moreover, for increasing playfulness, an input interface is provided for enabling the operator to input his/her preferred environment status and thus defining the level of difficulty for playing.

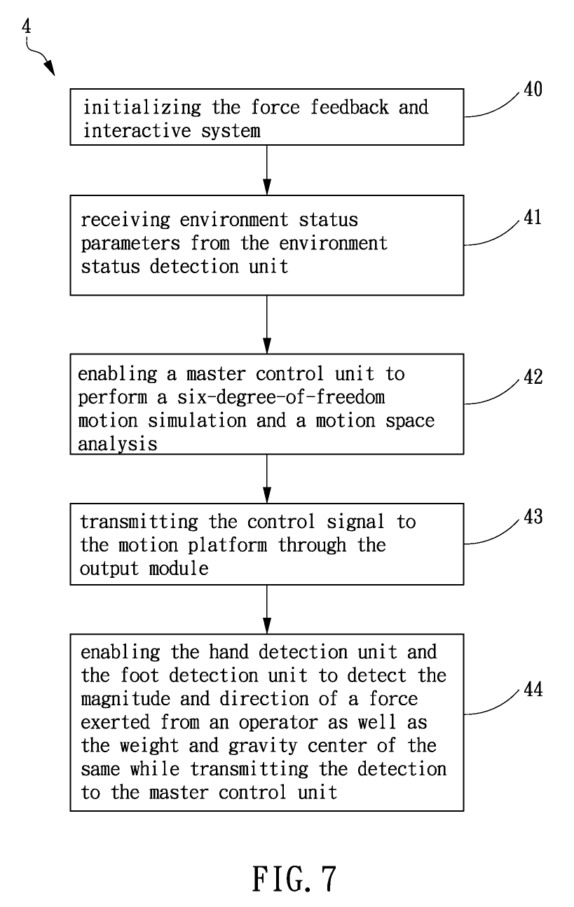

Please refer to FIG. 7, which is a flow chart depicting the operating steps being performed in the force feedback and interactive system according of the invention. The flow starts from step 40. At step 40, a force feedback and interactive system is initiated and then the flow proceeds to step 40. At step 41, the environment status detection unit is initiated for detecting environment status parameters; and then the flow proceeds to step 42. In this exemplary embodiment, the environment status parameters contains information relating to the sail's angle, wind power and wind direction, etc. At step 42, a master control unit is enabled to perform a six-degree-of-freedom motion simulation and a motion space analysis for generating a control signal, a feedback signal and an image processing signal; and then the flow proceeds to step 43.

At step 43, the control signal is transmitted to the motion platform through the output module; and then the flow proceeds to step 44. It is noted that as the motion platform is able to perform a multi-axial movement, it can generating an instantaneous motion and displacement according to the direction of the control signal. In addition, as the feedback signal is transmitted to the force detection/feedback unit, i.e. to the hand detection unit and the foot detection unit, force responding to the feedback signal will be generated by the force detection/feedback unit and thus to be felt by the operator as interaction. Moreover, as the image processing signal is transmitted to the display unit through the visual effect and gaming unit, the display unit is enabled to display images corresponding to the motion and displacement of the motion platform. For instance, as the motion platform is a boat in this embodiment, the sight of the sea level or view sought in the visual field of the operator is changing with the displacement and movement of the motion platform while such changing is displayed on the display unit.

In response to the scenario change and the movement of the motion platform, the operator is going to react and interact by exerting force to the hand detection unit and the foot detection unit, and such interactive response will be detected by the hand detection unit and the foot detection unit, as shown in step 44. At step 44, the hand detection unit and the foot detection unit is used to detect the magnitude and direction of a force exerted from an operator as well as the weight and gravity center of the same while transmitting the detection to the master control unit. The master control unit will perform a calculation basing upon the received environment status parameters, and the aforesaid detection to generate a control signal, a feedback signal and an image processing signal correspondingly to be received by the motion platform, the force detection/feedback unit and the display unit in respective. Therefore, by the repeating of step 40 to step 44, the operator is able to interact with the system in a dynamic and playful manner.

To sum up, the present invention provides a force feedback system capable of generating an output of feedback in responding to the direction and magnitude of a force detected by the system while using the feedback to interact with a user of the system. Moreover, although the hull used for supporting the operator is designed as a vessel in the aforesaid embodiment, it can be shaped like a surfboard, vehicle, or an airplane, etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A force feedback and interactive system, comprising:
a motion platform, capable of performing a multi-axial movement;
a force detection/feedback unit, mounted on the motion platform for detecting the magnitude and direction of a force exerted from a limb portion of an operator and thus generating a detection signal accordingly; and
a master control unit, coupled to the force detection/feedback unit for enabling the same to perform a calculation basing upon the detection signal and thus generating a control signal to the multi-axis motion platform and a feedback signal to the force detection/feedback unit.

2. The system of claim 1, wherein the force detection/feedback unit is a hand detection device capable of being mounted on hands of the operator.

3. The system of claim 2, wherein the hand detection device further comprises: a plurality of detecting/driving components, each connected to the master control for transmitting the its detected magnitude and direction of the force exerted from the operator in a space to the master control unit to be used in the calculation and also receiving the feedback signal from the master control unit so as to generate a force feedback to the operator.

4. The system of claim 1, wherein the force detection/feedback unit is a foot detection device capable of being mounted on feet of the operator.

5. The system of claim 4, wherein the foot detection device further comprise:
two supporting boards, each configured with a bottom axially connected to a rotating device while the rotating device is mounted on a fixed plate; and
a plurality of sensors, disposed on the supporting boards while electrically connected to the master control unit for enabling the same to detect forces resulting from the rotation of the supporting boards.

6. The system of claim 5, further comprising:
a weight and gravity center detection unit, disposed on a surface of the fixed plate and composed of a plurality of weight sensors, each respectively disposed at a side of any of the two supporting boards for detecting the weight and gravity center of the operator.

7. The system of claim 5, wherein a block is attached upon each of the two the supporting boards at a surface facing toward the fixed plate while a concave seat is mounted on the fixed plate at a position corresponding to the block, for enabling a plurality of sensor disposed inside the concave seat to be arranged at positions corresponding to the block.

8. The system of claim 1, wherein the master control unit further comprises:
a conversion and registration unit, for converting the detection signal; and
a calculation unit, coupled to the conversion and registration unit for performing a calculation basing upon the conversion result of the conversion and registration unit so as to obtain the control signal and the feedback signal.

9. The system of claim 1, wherein the master control unit further comprises:
a conversion and registration unit, for converting the detection signal;
a calculation unit, coupled to the conversion and registration unit for performing a calculation basing upon the conversion result of the conversion and registration unit so as to obtain the control signal and the feedback signal; and
a visual effect and gaming unit, coupled to the calculation unit for generating an image information of interaction according to the calculation of the calculation unit.

10. The system of claim 9, further comprising:
a display unit, coupled to the visual effect and gaming unit.

11. The system of claim 1, wherein the motion platform further comprises:
a carrier;
a base, arranged at a side of the carrier;
a pair of safety stops, sandwiched between the carrier and the base in a manner that each safety stop is coupled to the carrier and the base in respective; and
an actuating unit, coupled to the carrier for driving the same to perform the multi-axial movement.

12. The system of claim 1, wherein the master control unit further couples to an environment status detection unit.

13. The system of claim 1, wherein the motion platform is shaped like a platform selected from the group consisting of a vehicle, a vessel and an airplane.

14. A force feedback and interactive system is provided, comprising:
a motion platform, capable of performing a multi-axial movement;
a force detection/feedback unit, further comprising:
a hand detection device, capable of being mounted on the motion platform for detecting the magnitude and direction of a force exerted from hands of an operator and thus generating a first detection signal accordingly; and
a foot detection device, capable of being mounted on the motion platform for detecting the magnitude and direction of a force exerted from feet of the operator and thus generating a second detection signal accordingly; and
a master control unit, coupled to the force detection/feedback unit for enabling the same to perform a calculation basing upon the first and the second detection signals and thus generating a control signal to the multi-axis motion platform and a feedback signal to the force detection/feedback unit.

15. The system of claim 14, wherein the master control unit further comprises:
a conversion and registration unit, for converting the detection signal; and
a calculation unit, coupled to the conversion and registration unit for performing a calculation basing upon the conversion result of the conversion and registration unit so as to obtain the control signal and the feedback signal.

16. The system of claim 14, wherein the master control unit further comprises:
a conversion and registration unit, for converting the detection signal;
a calculation unit, coupled to the conversion and registration unit for performing a calculation basing upon the conversion result of the conversion and registration unit so as to obtain the control signal and the feedback signal; and
a visual effect and gaming unit, coupled to the calculation unit for generating an image information of interaction according to the calculation of the calculation unit.

17. The system of claim 16, further comprising:
a display unit, coupled to the visual effect and gaming unit.

18. The system of claim 14, wherein the motion platform further comprises:
a frame, further comprises:
a carrier; connected to a side of the frame;
a base, arranged at a side of the carrier; and
a pair of safety stops, sandwiched between the carrier and the base in a manner that each safety stop is coupled to the carrier and the base in respective; and
an actuating unit, coupled to the carrier for driving the same to perform the multi-axial movement.

19. The system of claim 14, wherein the master control unit further couples to an environment status detection unit.

20. The system of claim 14, wherein the motion platform is shaped like a platform selected from the group consisting of a vehicle, a vessel and an airplane.

21. The system of claim 14, wherein the foot detection device further comprises:
two supporting boards, each configured with a bottom axially connected to a rotating device while the rotating device is mounted on a fixed plate; and
a plurality of sensors, disposed on the supporting boards while electrically connected to the master control unit for enabling the same to detect forces resulting from the rotation of the supporting boards.

22. The system of claim 21, further comprising:
a weight and gravity center detection unit, disposed on a surface of the fixed plate and composed of a plurality of weight sensors, each respectively disposed at a side of any of the two supporting boards for detecting the weight and gravity center of the operator.

23. The system of claim 21, wherein a block is attached upon each of the two the supporting boards at a surface facing toward the fixed plate while a concave seat is mounted on the fixed plate at a position corresponding to the block, for enabling a plurality of sensor disposed inside the concave seat to be arranged at positions corresponding to the block.

24. The system of claim 14, wherein the hand detection device further comprises: a plurality of detecting/driving components, each connected to the master control for transmitting the its detected magnitude and direction of the force exerted from the operator in a space to the master control unit to be used in the calculation and also receiving the feedback signal from the master control unit so as to generate a force feedback to the operator.
